(19) United States
(12) Patent Application Publication
(10) Pub. No.: US 2006/0064306 A1
(43) Pub. Date: Mar. 23, 2006

(54) On-line credit information system

(76) Inventor: Dharam Pal, Hyderabad (IN)

Correspondence Address: Ramesh Babu Vishwanath, 48 SRT 1st Floor, Prakash Nagar Begumpet, Hunderabad, 500016, IN

(21) Appl. No.: 10/530,806

(22) PCT Filed: Nov. 24, 2003
(86) PCT No.: PCT/IN03/00368

§ 371 Date: Apr. 8, 2005

(30) Foreign Application Priority Data
Nov. 25, 2002 (SG) 200207092-8

(51) Int. Cl. G06Q 99/00

(52) U.S. Cl. 705/1; 705/38

(57) ABSTRACT

An on-line credit information System to collect information on businesses and individuals, and to disseminate the same to the seeker of the information alone. Participants to the System include a System Administrator, Subscribers and Non-Subscribers. Subscribers and Non-Subscribers can be either individuals or businesses. A Subscriber seeks information on a Subject by making a small payment to the System Administrator. He gets to receive information on the Subject from Subscribers and Non-Subscribers. The information on the Subject is made available only to the seeking Subscriber. Most of the information shall be in a pre-determined template with multiple choices. Information seeking Subscriber is required to rate the best response among several responses that he received to his query on a Subject. Such information providing Subscribers and Non-Subscribers shall be rewarded by the System Administrator by distributing a large part of the fee collected from information seeking Subscribers.

### FIELD OF INVENTION

The present invention relates to following:
An on-line credit information collection and dissemination method on businesses and individuals.

### BACKGROUND OF THE INVENTION

Credit information on businesses and individuals is a crucial element of conducting business, especially cross country business. Businesses, banks etc. rely upon this information to make a commercial decision. A reliable credit information can save a business millions of dollars and an unreliable credit information can cause large avoidable commercial losses. Similarly, lack of credit information leaves a business without a direction when it comes to commercial decision making process.

More often than not the required information is hard to come by. This is more so for businesses that are not large enough to be noticed by credit reporting companies or their contributors. Besides, businesses are shy of releasing financial performance in public domain. A privately held business can actually make sure that none knows about what is going on within, except of course a few people who are closely associated with it.

Further, in developed countries access to credit information is far greater and easier than compared to underdeveloped and developing countries. Developed countries have put in place relevant institutions and deployed technologies thereof to provide easy accessibility to such information, at least the basic information on a Subject. Though the infrastructure to access such information has been created in the developed countries there still remains room for improvement in terms of content and variety of information. Reason, current credit information providers have access to limited sources to collect information on a given Subject.

Situation is pathetic when it comes to developing and underdeveloped countries. These countries have far inferior level of infrastructure in this sector. The information is either not available or is in a highly fragmented form. With the result businesses in these countries are a big loser when it comes to doing business. Other businesses would not like to do business with a business in these countries as there is no or very little information available on the businesses there. This leads to imperfect flow of goods, services and capital.

With ever increasing globalisation in goods and services information (business intelligence) on businesses is going to acquire increasing significance in times to come. However, the current mechanisms in place have their own limitations in satiating this burgeoning appetite for information on businesses.

The situation is just about the same or worse for information on individuals. Credit information on individuals is far more difficult to come by as individuals are far more private ‘entities’ than businesses.

### DESCRIPTION OF THE PRIOR ART

Currently credit information on businesses and individuals is made available by professional credit information providers i.e. Dun & Bradstreet, Experian, Equifax, Coface etc. Current providers rely upon certain sources for their information. Some of the information that they procure is through their own internal mechanisms and other from their external sources. Usually such sources are Subject itself, its business associates, bankers, insurers, registrar of businesses/companies etc.

Quality and usefulness of the information provided by current credit information providers is very much dependent upon their sources. They are not able to get best quality information consistently on all the Subjects that they report on, thus making it difficult for businesses in making business decisions. Further, their network of sources is skewed as they are strong in one geographical region while weak in another.

Therefore quality of reports generated by current credit information providers is not consistent. As a matter of fact it can not be, as they face a daunting task in collecting this information. Further, richness of their report is limited by their limited sources for information. Any credit information provider can have only so many sources, it cannot be limitless. Again, all sources of such information cannot be top category. In some cases they either do not get any information or get a very skeletal set of information which is of no use to the business seeking that information.

The cost of such information provided by the current credit information providers is rather prohibitive due to the logistics involved in gathering that information. Besides, manpower engaged in collecting and analysing that information is highly qualified and expensive. Hence, not every business can afford to buy credit information report from current information providers. Even bigger businesses in some cases do without a credit information report if the value of underlying transaction with the said Subject is not substantial because cost of credit information report is not justifiable. It is also a common refrain among businesses that even if one pays to get credit information report on a Subject most of the times the report has no meat in it. More often than not a credit report is merely a fact sheet of a Subject, a validating document. Instead of a decision support report.

Further, it takes a long time to receive credit information report from current providers as they need to gather the same from different sources in far away countries through their partners etc. Sometimes by the time the report arrives it is of no use to the business seeking it.

To sum it up the current credit information reporting system, though conducted very professionally, has several inefficiencies i.e. limited or no information, delayed reports, costly etc. Such inefficiencies are unavoidable in a brick and mortar environment as the sheer magnitude of logistics involved in collecting such information is daunting.

Current credit information providers have not looked at deploying internet to collect such information through the tools provided thereof to eliminate inefficiencies from current processes.

### SUMMARY OF THE INVENTION

It is an object of the present invention to provide an on-line Credit Information System for collection and dissemination of credit information on businesses and individuals. The proposed system alleviates, almost fully, most of the above-mentioned problems that impact current credit information providers.

Accordingly in one aspect of the present invention consists in an online Credit Information System* which includes as participants, a System Administrator**, Subscribersˆand Non-Subscribersˆˆ, characterised in that:
*‘Credit information System’ refers to proposed on-line Credit Information System.

**‘System Administrator/Administrator’ refers to an entity that shall administer the System.

ˆˆ‘Subscribers’ are individuals and businesses who have registered themselves with the System.

ˆˆ‘Non-Subscribers’ are individuals and businesses who have not registered themselves with the System.

System Administrator administers the System,
Subscribers are those individuals and businesses, who have registered themselves within the System,
Registration within the System is free of charge,
Non-Subscribers are those individuals and businesses, who have not registered themselves within the System,
   Each Subscriber has a user ID/password,

Subscribers to the System shall be able to seek information on a Subject* i.e. business or individual through the System from its Subscribers and/or Non-Subscribers. The Subscribers need to provide minimum information on the Subject i.e. Name, location, address etc. to seek opinion of the public on the said Subject. They need to pay a small fee, of say $5/−, to seek information on each Subject.
*“Subject or Subjects” refers to business or individual on whom a Subscriber seeks information through the System.

Subscribers and Non-Subscribers shall be able to provide information on as many Subjects as they like. They do not get paid for the information thus provided by them. Information thus provided by Subscribers and Non-Subscribers is e-mailed out to the information seeking Subscriber alone. In other words information thus provided shall not be available to anyone other than the seeking Subscriber.

System Administrator shall provide a pre-determined template containing several relevant fields on a business i.e. date of incorporation, number of employees, share capital, revenue turnover etc. Each field shall have a few choices. An information provider is to select the applicable field(s).

Information seeking subscriber shall be able to receive several responses from different Subscribers and Non-Subscribers. He is required to rate the best response from among the responses received. If he fails to do so he shall be charged higher fee next time when he seeks information on a Subject through the System.

System Administrator shall carry out a lottery periodically (daily/weekly/monthly) from among the Subscribers and/or Non-Subscribers whose responses have been rated best by information seeking Subscribers. A few of these respondents shall be given away rewards from the fee paid by information seeking Subscribers.

### BRIEF DESCRIPTION OF THE DRAWING

Appendix-1 is a sample of predetermined template that an information providing Subscriber and/or Non-Subscriber shall be required to fill out.

### DESCRIPTION OF THE PREFERRED EMBODIMENTS

The present invention is an online credit information System involving various categories of parties whom have joined up to the System: System Administrator, Subscribers and Non-Subscribers. The main parties are the information seeking Subscribers and information providing Subscribers/Non-Subscribers. Subscribers are required to register themselves within the System. They can do so online.

There will be two categories of users, a) Subscribers and b) Non-Subscribers. The Subscribers/Non-Subscribers can be either individuals or businesses etc. Each Subscriber shall have a unique System Identifier (user ID/password).

In use, information seeking Subscriber logs in to the System web site by providing his user ID/password and opts to seek information on a Subject. He is required to provide basic information on the Subject i.e. name, location, contact details etc. on the said Subject. It is likely that he may or may not have all the necessary basic information on a Subject. In which case, he provides as much information on the Subject as he can. He also needs to specify as to how many responses he would like to receive and also for how long he would like to receive such responses. The fee to be paid by him shall depend upon these two factors. He will be required to pay a basic fee, of say $5/-, to receive responses on a Subject.

Once a Subscriber or Non-Subscriber has opted to provide information on a Subject he needs to click on the Subject's name and then he would see a large template containing various fields relating to Subject where he needs to provide the information. For each field that he decides to provide information there will be multiple choices provided and he needs to select one or more choices from several options provided therein. He may or may not be given an opportunity to write a comment on his own for any of the fields.

Information seeking/receiving Subscriber may opt to receive responses in a consolidated e-mail or on as and when it is submitted by information providing Subscribers and/or Non-Subscribers. He needs to inform the System Administrator as to which particular response from Subscriber or Non-Subscriber was the most useful. If he fails to do so he will be charged a higher amount, say $10/−, next time if he were to seek information on a Subject through the System.

Each enquiry posted on a Subject may elicit several responses. Only one such response shall be declared as best response by the information seeking/receiving Subscriber. This means for each enquiry there will be one Subscriber or Non-Subscriber as best respondent. This will form a ‘best respondents’ club’. The System shall now pick top 3 (or more or less) lucky winners out of the ‘best respondents’ club’ for the day or week or month. The top 3 winners thus selected shall be given away a substantial portion of the fee collected from the information seeking/receiving Subscribers.

All the participating entities to the System come together in a win-win arrangement. The seeking Subscriber spends an insignificant amount to get the information on a Subject. If he is lucky he may get a very valuable piece of information on a Subject by spending that measly sum of money. The information providing Subscribers and/or Non-Subscribers stand to win large cash rewards for providing quality responses on a given Subject. The System Administrator stands to benefit by retaining certain portion of the fees collected from the information seeking Subscribers.

Appendix-1 is a sample of the proposed pre-determined template that will be made available to the information providing Subscriber and/or Non-Subscriber once he opts to provide information on a Subject from the list of Subjects listed. The given sample is merely illustrative not exhaustive. The information providing Subscriber and/or Non-Subscriber shall be given minimum opportunity to write a comment on his own. Most of the information shall be captured through multiple choice answers. This is to avoid abuse of the System by Subscribers and Non-Subscribers who have chosen to provide information on a Subject.

System Administrator shall do the necessary due diligence from legal angle before putting up the template within the System. This is to ensure that there are no legal disputes arising out of the information provided by Subscribers and/or Non-Subscribers.

As the information provided is being made available only to the seeking Subscriber and not being made available in the public domain through a bulletin board etc. within the System the liability issues are covered to a large extent. The seeking Subscriber shall sign up relevant agreement with the System Administrator to not to disclose the information received on a Subject through the System.

It is likely that many a times the information received through the System is not of any use to the seeking Subscriber. However, the cost of seeking this information is insignificant and there is always a potential to get some very crucial information on a Subject which is otherwise not possible to obtain. Hence, businesses may not mind using the System to receive information from myriad sources that may end up providing information on a Subject. They will treat the cost as a small insurance premium that they pay to do a transaction with a Subject. A traditional credit information providing company cannot possibly have such large variety of sources to obtain the information.

Information providing Subscribers and/or Non-Subscribers usually have no reason to provide information on a Subject just like that. System Administrator shall make the whole process so compelling through cash rewards etc. that in time to come it will have a dedicated set of contributors from each geographical location that would provide information on Subjects located in their home country/city. System Administrator, if deemed fit, may even employ such contributors if they have consistently been rated best respondents by various information seeking Subscribers.

This could be a platform for retired bank/business professionals to intellectually engage themselves and also earn some money. Even bankers and other trade professionals, especially the retired ones, would want to contribute regularly and make some money in the process. As identity of respondents is not disclosed to seeking Subscriber a contributor can safely provide all the information that he wants to. The process may throw up information that may never be made available on a Subject otherwise through extant credit information services.

It is an earnest objective of the proposed System to make credit information on businesses and individuals available on tap and at a price which does not pinch the business seeking it. This would lead to increased global trade in goods and services. It will help in eliminating inefficiencies from flow of goods, services and capital across countries. The System may not be able to cannibalize the existing credit information providers but shall certainly complement them and shall be a great tool in the hands of businesses at a cost that is totally insignificant. It is likely that in certain cases System is able to provide better information on a Subject than the one by traditional credit information providers.

Actual lead time for receipt of credit information through the System by seeking Subscriber can sometimes be less than an hour. An information seeking Subscriber can opt to receive information posted by providing Subscribers and/or Non-Subscribers in a consolidated manner or as and when it is provided by Subscribers/Non-Subscribers. He could also determine as to how many such responses he would like to receive and for how long he would like to keep receiving such information. The System Administrator shall bill him accordingly

It is to be appreciated that the foregoing is illustrative and limiting of the invention, and that various changes and modifications described above will be apparent to those skilled in the art. Such changes and modifications can be made without departing from the spirit and scope of the present invention, and it is therefore intended that such changes and modifications be covered by the following claims:

### Appendix-1

1) . . . is a trading/manufacturing/service organization; It is a . . . private limited company/firm/public listed company/government undertaking. 2) It is located at . . . (full adds with city, country name). 3) It is a . . . (number) years old company. 4) Its Tel no. . . . Fax no. . . . e-mail . . . web site adds . . . 5) It is engaged in trading/manufacturing/service of . . . or it provides legal/accounting/other services. 6) It employs . . . (number) employees. 7) It has . . . office(s) in city. 8) It has . . . (number) office(s) in this country in . . . (number) cities. 9) It has . . . overseas office(s) in . . . (number) countries. 11) Its overseas offices are located in . . . (names of countries/cities) 12) It is part of . . . Group. 13) Its main promoters are . . . (names of promoters) 14) It has . . . (number) associate/subsidiary companies. 15) It is a professionally/family/individually managed company/business. 16) Its main bankers are . . . (names of banks to choose from and other banks to write). 17) Its total bank borrowings are . . . (range of amounts to choose from) 18) Its major source of revenue comes from . . . markets (names of the countries). 19) It is especially recognized for its . . . (product/service name). 20) Last year it did a turnover of . . . (range of amounts to choose from) and its net profit/loss was . . . (range of amounts to choose from). 21) It is likely to do higher/lower turnover this year. 22) Its paid up capital is . . . (range of amounts to choose from). 23) Currently its share is quoted at . . . (currency & amount) at . . . (Stock Exchange's name). 24) Its other business interests are in . . . products/services etc). 25) It is believed that the business has claims amounting to . . . (range of amounts to choose from) against . . . (names of business and their location). 26) It is believed that there are claims against the business amounting to . . . (range of amounts to choose from) from . . . (names of businesses and their location). 27) It was recently featured in news . . . (publication/neswpaper's name and dale or website hyperlink). 28) It has a very good/good/fair/bad/very bad reputation here. 29) Any other comment on the Subject . . .

1. An on-line credit information collection and dissemination System which includes as participants a System Administrator, Subscribers and Non-Subscribers, characterised in that a) System Administrator is an independent entity, who operates the System, b) Subscribers and Non-Subscribers are either individuals or businesses, c) Businesses and individuals register themselves online on System Administrator's web site and become Subscribers, d) A Non-Subscriber can only provide information on a Subject, he can not seek information on a Subject through the System,

2. An on-line credit information System according to claim 1 wherein said System Administrator maintains a database of Subscribers and Non-Subscribers, wherein each Subscriber has a System identifier (user ID/password) which is held by the Administrator and which must be provided along with password at System Administrator's web site to seek information on a Subject or provide information on a Subject; Administrator shall validate a Subscriber and allow him to seek information and/or provide information on a Subject through the System,

3. An online credit information System according to claim 2 wherein a Subscriber is required to make payment to the System Administrator while seeking information on a Subject through the System,

4. An online credit information System according to claim 3 wherein Subscribers and/or Non-Subscribers voluntarily provide information on a Subject to the information seeking Subscriber through the System; Information provided by a Subscriber and/or Non-Subscriber is either through a multiple choice method in a pre-determined template or in the form of narration where he has the ability to write on a particular aspect of a Subject.

5. An online credit information System according to claim 4 wherein information thus provided by Subscriber and/or Non-Subscriber is made available only to the information seeking Subscriber; Information seeking Subscriber is required to rate the best response from among the various responses received by him; In the event of failure on the part of information seeking Subscriber to rate the best response from among the responses received by him he shall be charged a higher fee next time if he were to seek information on a Subject through the System,

6. An online credit information System according to claim 5 wherein System Administrator shall carry out a lottery on periodic (daily/weekly/monthly) basis from among the various Subscribers and/or Non-Subscribers whose responses have been rated the best by respective information seeking Subscribers whereby a few respondents shall be rewarded by distributing a substantial amount of fee paid by the seeking Subscribers during that period; Information providing Subscribers and/or Non-Subscribers do not get paid for providing information; Information providing Subscribers and/or Non-Subscribers stand a chance to win large cash reward if their quality of response is appreciated by the information seeking Subscriber.

7. An online credit information System according to claim 3 and claim 4 wherein said Administrator database stores a pre-determined template containing various fields relevant to a Subject that shall form part of the credit information report on a Subject provided by a Subscriber and/or Non-Subscriber to an information seeking Subscriber,

8. An online System/Service according to claim 1, claim 2, claim 3, claim 4, claim 5, claim 6 and claim 7 wherein System Administrator makes use of the same process of collecting and disseminating information for other purposes i.e. on celebrities, on places, on issues etc.

9. An online credit information System according to claim 1 wherein potential Subscribers provide their bank account details at the point of registration to be admitted to the System as Subscribers so that they would be able to receive cash rewards for giving quality information on Subjects to the information seeking Subscribers.
